(19) United States
(12) Patent Application Publication
(10) Pub. No.: US 2026/0001105 A1
(43) Pub. Date: Jan. 1, 2026

(54) Lift, Sprayer, and Tank Skid for Distribution of Water

(71) Applicants: Brannon Fowler, Elmendorf, TX (US); Brandon Brzozowski, Elmendorf, TX (US)

(72) Inventors: Brannon Fowler, Elmendorf, TX (US); Brandon Brzozowski, Elmendorf, TX (US)

(21) Appl. No.: 18/754,839

(22) Filed: Jun. 26, 2024

(51) Int. Cl. B08B 3/02

(52) U.S. Cl. CPC B08B 3/02; B08B 2203/0223

(57) ABSTRACT

The invention is a device for automating the distribution of water or other liquids through a lift, sprayer, and tank skid assembly. One embodiment of the present invention comprises a skid capable of lifting trash cans and other articles, distributing water and cleaning fluid to the trash can, retrieving distributing water, and returning the trash can to the ground.

### CROSS REFERENCES TO RELATED APPLICATION

Not applicable.

### FEDERALLY SPONSORED RESEARCH OR DEVELOPMENT

Not applicable.

### BACKGROUND OF THE INVENTION

### 1. Field of the Invention

This invention relates to water distribution systems including vehicular and trailer mounted water systems for cleaning garbage bins and other objects. Of course, the invention can be used in stationary/immovable assemblies.

### 2. Description of the Related Art

A number of systems exist for cleaning trash cans and other devices, and additional systems exist for distributing water for cleaning applications. U.S. Pat. No. 10,864,561 and other references describe devices for lifting trash can with arms and other auxiliary equipment to a work truck. U.S. Pat. No. 10,864,561 by Conway, in particular, describes “[a] vehicle mounted garbage bin cleaning system including power takeoff includes a pair of arms configured for lifting a garbage bin, the pair of arms rotatably coupled to a mount on the vehicle, a hopper configured for accepting the garbage bin when the pair of arms lifts the garbage bin into the hopper, at least one spray rod extending upwards from the hopper, said spray rod including a water nozzle, wherein when the pair of arms lifts the garbage bin into the hopper, the spray rod is situated within the garbage bin, a hydraulic pump mechanically coupled with a transmission of the vehicle, such that the transmission drives the hydraulic pump, a hydraulic motor hydraulically coupled with the hydraulic pump, a pressure washer pump mechanically coupled to the hydraulic motor, the spray rod fluidically coupled with the pressure washer pump.”

U.S. Patent Application No. 63/336,180 (the '180 Application) and applications claiming priority thereto teaches the use of solenoid valves—or their equivalents-instead of manual valves in several embodiments to move water for the use of trash can/bin cleaning systems. By using solenoid valves, the invention described in the '180 Application uses solenoid valves—or their equivalents-instead of manual valves in several embodiments to move water for the use of trash can/bin cleaning systems. By using solenoid valves, the invention in the '180 Application also incorporates a controller which allows the operator to time the distribution of water. In certain embodiments, the operator can perform all of the tasks from the cabin of the truck without exiting also incorporates a controller which allows an operator to time the distribution of water. In certain embodiments, the operator can perform all of the tasks from the cabin of the vehicle without exiting the vehicle.

References such as U.S. Pat. No. 10,864,561 have their shortcomings. For example, the assemblies described in U.S. Pat. No. 10,864,561 are large and take up substantial space. The large footprint makes it more difficult to move the vehicle, park the vehicle during use, and store the vehicle when not in use. It also increase the cost of fuel. It also requires more skilled and experienced operators. The assemblies described in U.S. Pat. No. 10,864,561 are also expensive. The unit is expensive but so to is the vehicle required to transport the unit. The expense raises the barrier to entry and decreases operator accessibility and the number of customers who can benefit.

The present invention solves these short comings by allowing facilitating use of the invention on the back of a pickup truck, a flat bed, or similar vehicle. As a result, an operator requires less space during use and during storage. The smaller assembly permits use of a smaller vehicle. The smaller assembly and smaller vehicle each cost less than the assembly/vehicle described in U.S. Pat. No. 10,864,561.

### BRIEF SUMMARY OF THE INVENTION

The invention is a skid that may be placed in the bed of a pickup truck, flat bed truck, or similar location, for the cleaning of trash cans and other units by way of lift assembly, and distribution of water or other liquids. One embodiment of the present invention comprises a platform, which serves as a base for holding a lift, a water basin, a water storage tank, a sprayer, and a motor and pump that move water from the water storage tank to the sprayer.

### BRIEF DESCRIPTION OF THE SEVERAL VIEWS OF THE DRAWINGS

For an improved understanding of the present invention, and the advantages thereof, reference is made to the following descriptions taken in conjunction with the accompanying drawings. The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 is a perspective view of the embodiment of the present invention.

FIG. 2 is an exploded view of the embodiment of the present invention shown in FIG. 1.

FIG. 3 is a front side view of an embodiment of the present invention shown in FIG. 1-FIG. 2.

FIG. 4 is a front view of the embodiment of the present invention shown in FIG. 1-FIG. 3 focusing on specific units.

FIG. 5 is a side view of the embodiment of the present invention shown in FIG. 1-FIG. 4.

FIG. 6 a rear side view of the embodiment of the present invention shown in FIG. 1-FIG. 5.

FIG. 7 a side view of the embodiment of the present invention shown in FIG. 1-FIG. 6.

### DETAILED DESCRIPTION OF THE INVENTION

### 1. General Considerations.

The present invention disclosure is for a lift, sprayer, and tank skid for distribution of water. The invention is described by reference to various elements herein. It should be noted, however, that although the various elements of the inventive apparatus are described separately below, the elements need not necessarily be separate. The variety of different ways of forming an inventive apparatus, in accordance with the disclosure herein, may be varied without departing from the scope of the invention.

Generally, one or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices and parts that are connected to each other need not be in continuous connection with each other, unless expressly specified otherwise. In addition, devices and parts that are connected with each other may be connected directly or indirectly through one or more connection means or intermediaries.

A description of an aspect with several components in connection with each other does not imply that all such components are required. To the contrary, a variety of optional components may be described to illustrate a wide variety of possible embodiments and in order to more fully illustrate one or more embodiments. Similarly, although process steps, method steps, or the like may be described in a sequential order, such processes and methods may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, or method is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Alternate implementations are included within the scope of various embodiments in which, for example, functions may be executed out of order from that shown or discussed, including substantially concurrently or in reverse order, depending on the functionality involved, as would be understood by those having ordinary skill in the art.

### 2. Considerations Specific to the Invention.

The present invention is a skid used for improving the distribution of liquid (e.g., water) from a source such as a storage tank to a water head, a wand, or the like. Other features comprised in certain embodiments are discussed below.

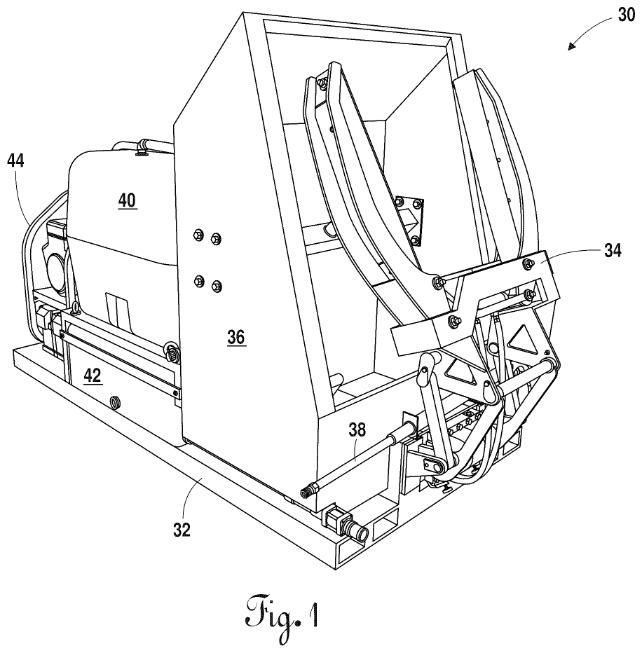

FIG. 1 illustrates one embodiment of the present invention. This embodiment is skid 30 for distributing water and other fluids. The skid 30 comprises several major units, each of which contains several components. The major units illustrated in FIG. 1 include platform 32, arm assembly 34, water basin 36, sprayer 38, primary tank 40, secondary tank 42, and engine and pump skid 44.

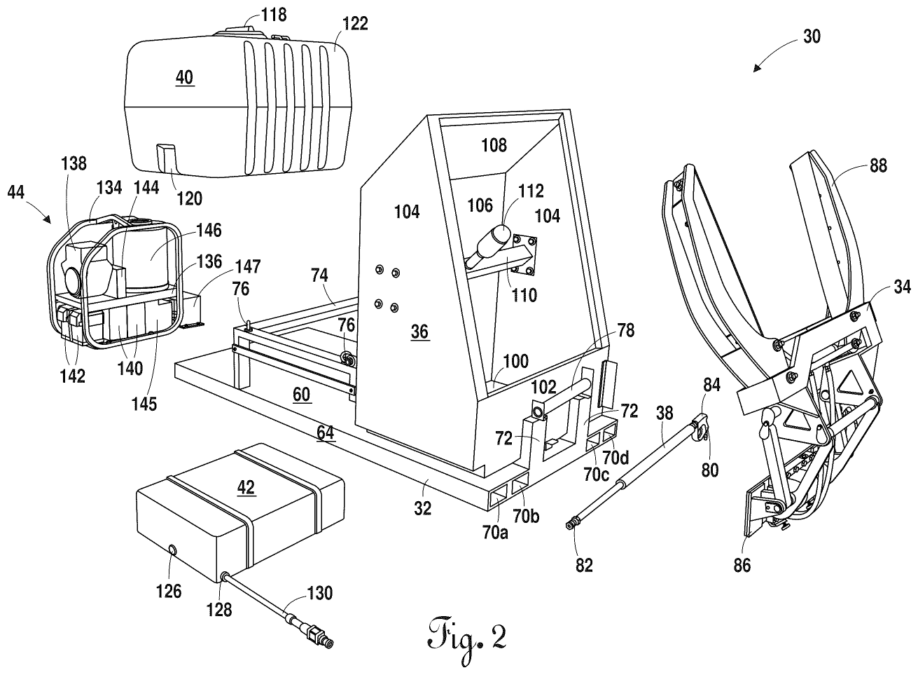

FIG. 2 illustrates an exploded view of the present embodiment shown in FIG. 2, which includes each of the several major units shown therein. In this embodiment, platform 32 is a metal body having several attributes including a top face 60, a left face 62, aright face 64 (not shown), a front face 66, and a rear face 68 (not shown). It is anticipated that a user will position the skid on a flat bed or in the bed of a pickup truck. To facilitate moving the skid from the ground to a bed, the user can use a forklift, extending the tines of the forklift into one or more of the lifting channels 70a, 70b, 70c. 70d, which extend from front face 66 to rear face 68. In some embodiments, the lifting channels might not extend fully between the two faces. Vertical posts 72 extend perpendicularly from platform 32 at front face 66. Vertical posts 72 serve several purposes in this embodiment. The arm assembly 34 can mount to the vertical posts. The sprayer can rest/mount on the vertical posts. In this embodiment, vertical posts 72 further separate the water basin 36 and the sprayer 38.

Tank frame 74 mounts to the top face 60 and will hold primary tank 40 and secondary tank 42 in place. The water basin 36 rests between the tank frame 74 and the vertical posts 72. In this embodiment, tank frame hardware 76 exists on the tank frame 74 and is used with cables and similar equipment to secure the primary tank in place, especially while in transit.

Arm assembly 34 comprises several components, including mounting panel 86 and arms 88. The mounting panel 86 attaches to vertical posts 72. The operation of the arms is discussed below.

Water basin 36 comprises several components, including floor 100, front wall 102, side walls 104, rear wall 106, ceiling 108, fixed sprayer mount 110, fixed sprayer 112. When engaged, the user activates a controller (not shown in FIG. 2) on the exterior of the water basin 36. At that point, water enters the fixed sprayer mount 110 and exits through the fixed sprayer 112. The water sprayer is intended to recapture water sprayed into the trash can either from sprayer 38 or fixed sprayer 112. Because the trash can is held upside down (or close to it) by the arms 34, water enters the trash can and flows out. Most, if not all of such water, returns to the water basin where it falls to the floor 100 and pools between each of the walls 102, 104, 106 until it exits a port (not shown) in floor 100.

Sprayer 38 comprises several components, including holster 78, wand inlet 80, wand outlet 82, and wand handle 84. When not engaged, the sprayer rests in the holster 78. When engaged, the user pressed down on a trigger positioned in the wand handle 84. At that point, water enters the sprayer through wand inlet 80 and exits through wand outlet 82.

Primary tank 40 comprises several components, including port 118, indention(s) 120, and grooves 122. Water intended for spraying is stored in primary tank 40 until it is deployed to the fixed sprayer of the water basin or sprayer 38. In most situations, the user will add water to the primary tank using a hose or nozzle that delivers water through port 118. Water exits primary tank (for delivery to sprayer 38 and/or fixed sprayer 112) through an outlet (not shown) on the bottom of primary tank or along the indention(s) 120. The grooves 122 add friction for straps to secure primary tank to tank frame 74.

Secondary tank 42 can be used for several purposes. The user can store cleaning solution and/or extra clean water. Alternatively, the user can store gray water in the secondary tank until user is ready to dispose of gray water from the system. Here, secondary tank 42 comprises several components, including ports 126, 128, and piping 130. In this embodiment, gray water exits the water basin 36 and enters secondary tank 42. The user can continue operating the skid and/or drive his vehicle with the stored gray water. When ready, the user can dispose of the gray water by unplugging port 126 or opening port 128 and directing ray water through piping 130. In this embodiment, piping 130 rungs alongside and underneath part of water basin 36 (where a void in the basin exists).

Engine and pump skid 44 comprises several components, including cage 134, platform 136, engine 138, fuel tanks 140, batteries 142, pump 144, a burner 145, a burner coil and hosing 146 (which heats the water), and a hydraulic unit motor and/or motor cover 147. This embodiment of the invention uses an engine and pump skid, namely, Pressure Pro HOT2GO SK Series Direct Drive SK30005VH. The engine and pump skid 44 supplies power to various operations of the present invention 30 (e.g., moving water to sprayer 38 and fixed sprayer 112; moving arm assembly 34).

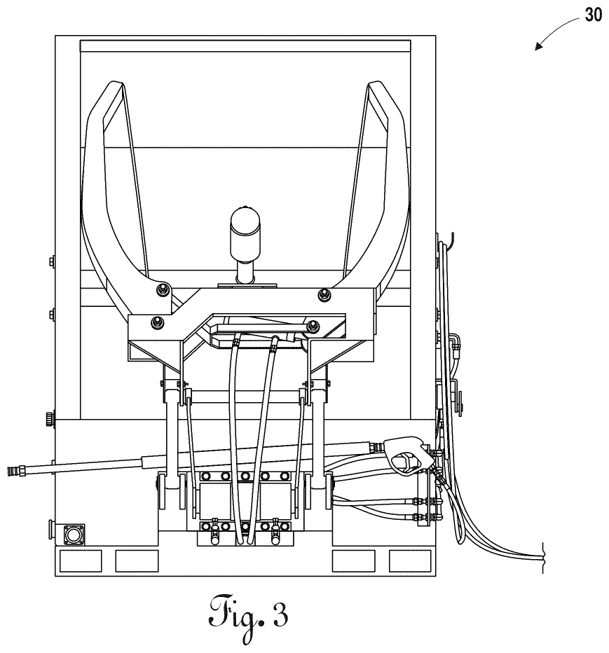

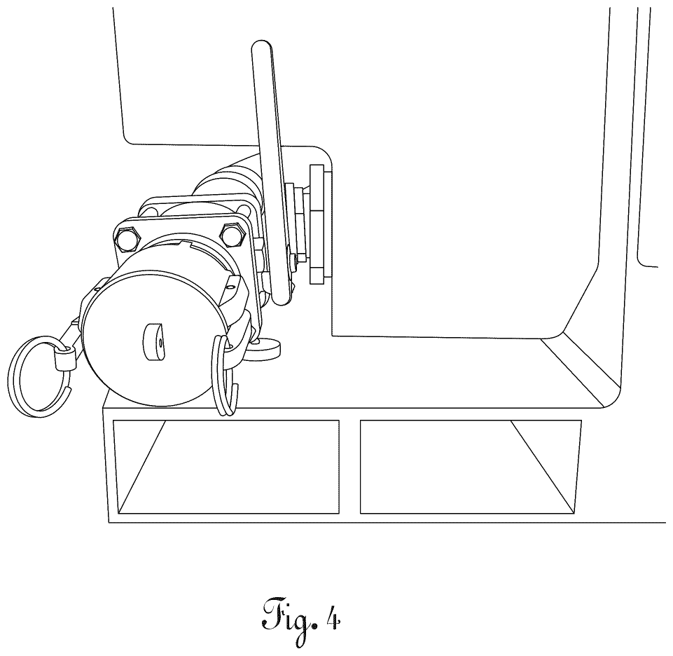

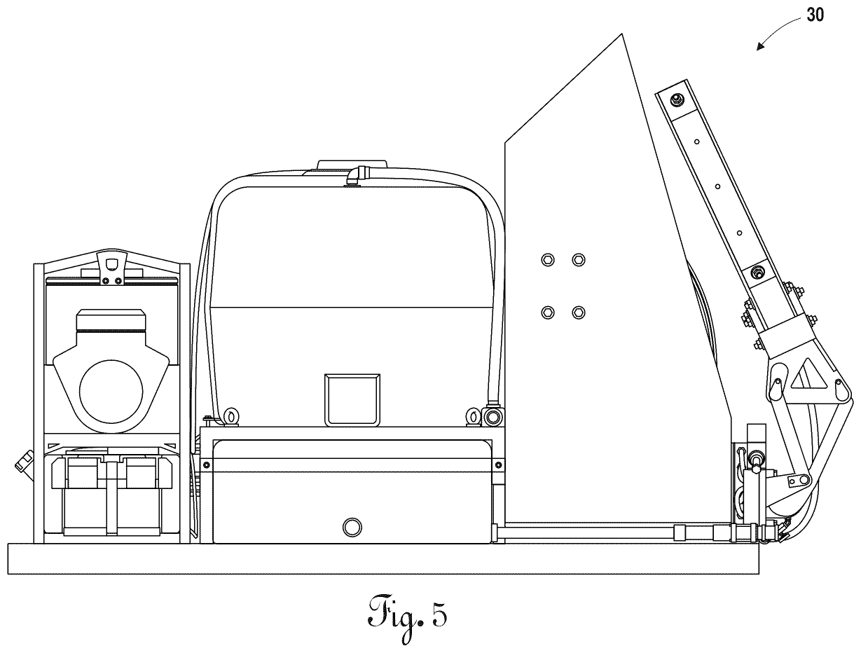

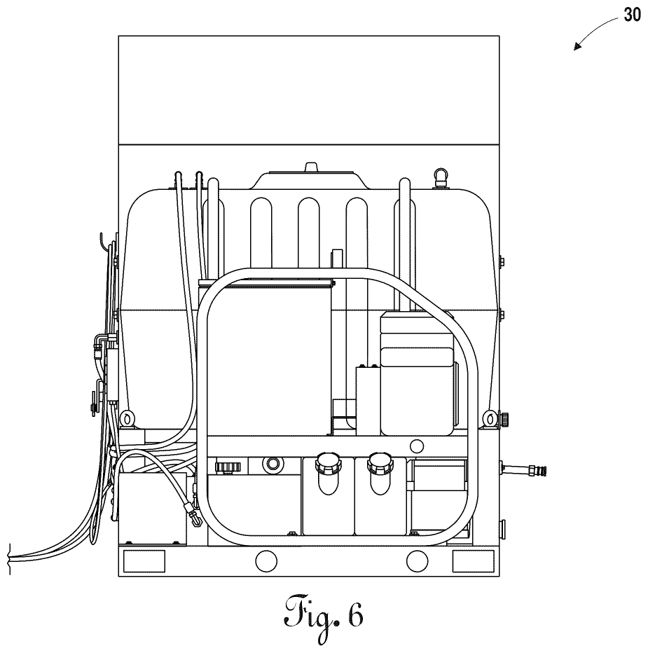

FIG. 3 is a front side view of an embodiment of the present invention. FIG. 4 illustrates a close up view of piping 130 as it exists in proximity with the water basin 36 and platform 32. It includes a cap and a lever used to stop water from moving and facilitate movement of water. FIG. 5 illustrates a side view of the invention. FIG. 6 illustrates a rear view of the invention with details of the engine and pump skid 44 and hosing and cables extending from the engine and pump skid 44 to other operating units.

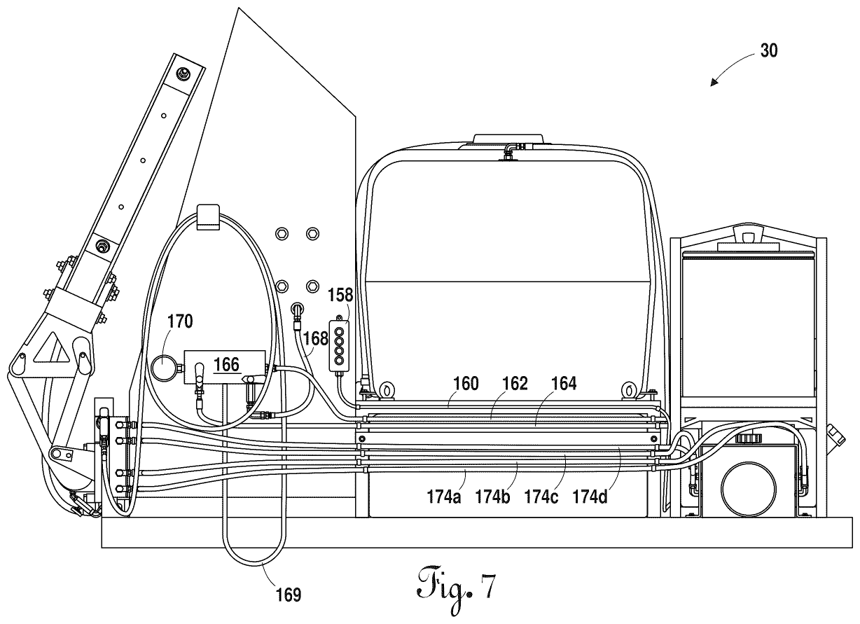

FIG. 7 illustrates a different side view of the invention, capturing the hosing and cables extending from the engine and pump skid 44 to other operating units. Controller 158 mounts to one of the water basin side walls 104. Controller 158 allows the user to manipulate the arm assembly 34 using a combination of four buttons. Cable 160 provides power from the hydraulic unit (engine and pump skid 44) to the controller 158. Cable 162 is an inlet line of water from the burner coil 146 to the manifold 166. Cable 164 is a bypass line circulating water between the manifold 166 and the primary tank 40.

Manifold 166 facilitates the movement of water between its source and its outputs (e.g., fixed sprayer 112; sprayer 38). Pressure valve 170 allows the user to monitor/control the water pressure at the manifold. For water that leaves the system, it exits manifold 166 and passes through hose 168 to the fixed sprayer 112 and/or through hose 169 to the sprayer 38.

FIG. 7 further illustrates hydraulic lines 174a, 174b, 174c, 174d, each of which is used to adjust one movement of the arm assembly 34. These movements are upward lift; downward lift; open arms; close arms. Although the particular arrangement of the hydraulic lines and how they correspond with the four buttons of controller 158 and the specific movements are immaterial to this specific drawing, for discussion sake, one might assume that: the first button of controller 158 controls line 174a thereby controlling upward movement of the arm assembly 34 (lifting a trashcan from the ground to an upside-down position for cleaning); the second button of controller 158 controls line 174b thereby controlling downward movement of the arm assembly 34 (e.g., returning a trash can to the ground); the third button of controller 158 controls line 174c thereby controlling closing movement of the arm assembly 34 (e.g., securing the trashcan in the arms of the arm assembly 34 so that it can be lifted); and the fourth button of controller 158 controls line 174d thereby controlling opening movement of the arm assembly 34 (e.g., releasing the trashcan from the arm assembly 34 so that the arm assembly can return to a neutral position and the user can fish the project and move on to the next trashcan).

This application has presented several embodiments of the present invention and discussed various devices, etc. It is contemplated that these units and devices may exist in varying arrangements, combinations, and still reflect the spirit of the present invention. The prevent invention may be incorporated into other assemblies.

In alternative embodiments, the tank frame might not be a rectangular shape. For example, it could be circulate to accommodate a tank that is a sphere, cylinder or other round shape. It could be triangular to accommodate a tank that is a tetrahedron or triangular prism shape, etc.

In alternative embodiments, the fixed sprayer could move laterally in one or more directions/axis along the fixed sprayer mount. It further could rotated about itself or about the mount. There could be multiple sprayers.

The present invention is described above in terms of a preferred illustrative embodiment in which a specifically described assembly is described. Those skilled in the art will recognize that alternative constructions of such an apparatus, system, and method can be used in carrying out the present invention. Other aspects, features, and advantages of the present invention may be obtained from a study of this disclosure and the drawings, along with the appended claims.

### 3. Additional Considerations.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including.” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating the assembly through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

In some embodiments of the present invention, the device might include the manifold and solenoid valve assembly described in U.S. Patent Application No. 63/336,180 and applications claiming priority thereto.

I claim:

1. A skid for distributing fluids comprising:
a platform having a first face;
a first liquid storage container attached to the first face;
a power source attached to the first face;
a sprayer fluidly connected to the first liquid storage container;
a pump fluidly connected to the first liquid storage and the sprayer, the pump electrically connected to the power source and attached to the first face.

2. The skid for distributing liquids of claim 1 further comprising at least one solenoid valve electrically connected to the power source, the at least one solenoid valve having a fluid inlet and a fluid outlet; and the fluid inlet connected to the first liquid storage container.

3. The skid for distributing liquids of claim 2 further comprising a controller or relay assembly electrically connected to the at least one solenoid valve.

4. The skid for distributing liquids of claim 1 further comprising a liquid basin attached to the first face, the liquid basin having a drain.

5. The skid for distributing liquids of claim 4 further comprising a second liquid storage container fluidly connected to the liquid basin, the second liquid storage container attached to the first face.

6. The skid for distributing liquids of claim 4 further comprising at least one spray head fluidly connected to the first liquid storage container and attached to the liquid basin.

7. The skid for distributing liquids of claim 1 further comprises:
the platform having a length;
the platform having a receiving face and an opposing face located opposite from the receiving face; and
at least two orifices in the receiving face, the at least two orifices extending at least half the length of the first face.

8. A skid for distributing fluids comprising:
a platform having a first face;
a first liquid storage container attached to the first face;
a second liquid storage container attached to the first face;
a power source attached to the first face;
a sprayer fluidly connected to the first liquid storage container;
a pump fluidly connected to the first liquid storage and the sprayer, the pump electrically connected to the power source and attached to the first face;
a liquid basin attached to the first face, the liquid basin having a drain;
at least one spray head fluidly connected to the first liquid storage container and attached to the liquid basin;
the platform having a length;
the platform having a receiving face and an opposing face located opposite from the receiving face; and
at least two orifices in the receiving face, the at least two orifices extending at least half the length of the first face.
